(19) United States
(12) Patent Application Publication
(10) Pub. No.: US 2010/0154974 A1
(43) Pub. Date: Jun. 24, 2010

(54) METHOD OF MAKING A PNEUMATIC TIRE

(76) Inventors: Francois Pierre Charles Gerard Georges, Stavelot (BE); Jean-Michel Alphonse Fernand Gillard, Arlon (BE); Roland Willibrord Krier, Biwer (LU); Vincent Benoit Mathonet, Habay la Neuve (BE); Bernard Robert Nicolas, Arlon(Bonnert) (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/339,605

(22) Filed: Dec. 19, 2008

(51) Int. Cl. B29D 30/08

(52) U.S. Cl. 156/117

(57) ABSTRACT

A pneumatic tire comprising a tread, a carcass and a zigzag belt structure interposed between the carcass and the tread is provided. The zigzag belt structure is formed of at least two layers of cords interwoven together from a strip of rubber reinforced with one or more cords, wherein the strip forming the zigzag belt structure is layed up in a first zigzag winding extending from a first lateral belt edge to a second lateral belt edge in a zigzag wavelength having a first amplitude W1 followed by a second amplitude W2, and a second zigzag winding formed of a zigzag wavelength having a first amplitude W2 followed by a second amplitude W1.

### FIELD OF THE INVENTION

This invention relates to a pneumatic tire having a carcass and a belt reinforcing structure, and, more particularly, to radial ply tires for use in aircraft, trucks and other high load applications.

### BACKGROUND OF THE INVENTION

In tires that have heavy loads such as truck tires or aircraft tires, zigzag belt layers have been utilized for the belt package. Zigzag belt layers eliminate working belt endings at the shoulder. An exemplary portion of a tire with a zigzag belt layer 5 is shown in FIG. 1. The advantage of zigzag belt layers is that there are no working belt edges near the shoulder, which greatly improves tire durability. The disadvantage to zigzag belt layers is that at the edges near the shoulder, there are overlapping layers. In some areas there are too many layers, such as 4 or more layers typically, and even 6 or more layers in some locations. The reduction of overlapping strips in the shoulder area has been shown to improve durability. Thus it is desired to have a tire with improved belt edge durability without excess weight.

### SUMMARY OF THE INVENTION

The invention provides in a first aspect a method of making a pneumatic tire having a tread, a carcass and a zigzag belt structure interposed between the carcass and the tread, and forming the zigzag belt structure of at least two layers of cords interwoven together from a strip of rubber reinforced with one or more cords. The zigzag belt structure is made by forming the strip in a first zigzag winding having a first amplitude W1 followed by a second amplitude W2 extending in a direction opposite said first amplitude, wherein said amplitudes are measured from the axial centerplane, wherein W1 is different than W2, and then indexing the strip a desired axial distance. The method further includes the step of forming the strip in a second zigzag winding having a first amplitude W2 followed by a second amplitude W1 extending in a direction opposite said first amplitude, and then repeating each of said windings until the zigzag belt structure is formed.

The invention provides in a second aspect a method of making a pneumatic tire having a tread, a carcass and forming a zigzag belt structure over the carcass, wherein the zigzag belt structure is formed from the following steps: providing a strip of rubber reinforced with one or more cords, and laying up the strip in a first zigzag winding, wherein the wavelength has a first amplitude: WMax and a second amplitude Wmin, wherein the second amplitude extends in an opposite direction of said first amplitude relative to the center plane, and then axially indexing the strip. Next, laying up the strip in a second zigzag winding adjacent to said first zigzag winding, wherein said second zigzag winding having a first amplitude Wmin and a second amplitude Wmax; wherein the second amplitude extends in an opposite direction of said first amplitude relative to the center plane; and then axially indexing the strip. Then, laying up the strip in a third zigzag winding adjacent to said second zigzag winding, wherein the wavelength has a first amplitude: WMax and a second amplitude Wmin, and wherein each edge of the third zigzag winding is circumferentially offset from the edges of the first and second zigzag winding. Finally, laying up the strip in a fourth zigzag winding adjacent to said third zigzag winding wherein said fourth zigzag winding having a first amplitude Wmin and a second amplitude Wmax; wherein each of the edges of the fourth zigzag winding are circumferentially offset from the edges of the previous windings.

### Definitions

“Apex” means a non-reinforced elastomer positioned radially above a bead core.

“Aspect ratio” of the tire means the ratio of its section height (SH) to its section width (SW) multiplied by 100% for expression as a percentage.

“Axial” and “axially” mean lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Working belt” or “cut breaker reinforcing structure” means at least two cut layers of plies of parallel cords, woven or unwoven, underlying the tread, unanchored to the bead, and having both left and right cord angles in the range from 10 degrees to 60 degrees with respect to the equatorial plane of the tire.

“Bias ply tire” means a tire having a carcass with reinforcing cords in the carcass ply extending diagonally across the tire from bead core to bead core at about a 25-50 degree angle with respect to the equatorial plane of the tire. Cords run at opposite angles in alternate layers.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Chafers” refer to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Equatorial plane (EP)” means the plane perpendicular to the tire's axis of rotation and passing through the center of its tread.

“Flipper” means a reinforced fabric wrapped about the bead core and apex.

“Footprint” means the contact patch or area of contact of the tire tread with a flat surface at zero speed and under normal load and pressure

“Innerliner” means the layer or layers of elastomer or other material that form the inside surface of a tubeless tire and that contain the inflating fluid within the tire.

“Net-to-gross ratio” means the ratio of the tire tread rubber that makes contact with the road surface while in the footprint, divided by the area of the tread in the footprint, including non-contacting portions such as grooves.

“Radial-ply tire” means a belted or circumferentially-restricted pneumatic tire in which the ply cords which extend from bead to bead are laid at cord angles between 65-90 degrees with respect to the equatorial plane of the tire.

“Section height” (SH) means the radial distance from the nominal rim diameter to the outer diameter of the tire at its equatorial plane.

“Winding” means the pattern of the strip formed in a first revolution of the strip around a tire building drum, tire or core.

### BRIEF DESCRIPTION OF THE DRAWINGS

FIG. 1 is a schematic sectional view of part of a prior art tire having a zigzag belt;

FIG. 2 illustrates a partial cross-section of an exemplary radial tire 10 of the present invention;

FIG. 3 is an example of a tire building drum showing the belt of the present invention being formed;

FIG. 4A is an example of a tire building drum layed out circumferentially for illustration purposes illustrating a first full revolution of the strip layup forming the zigzag belt;

FIG. 4B is the tire building drum of FIG. 4A illustrating only a second revolution of the cord pattern of the zigzag belt (the first revolution was removed for clarity);

FIG. 4C is a closeup view of the strip at the belt edge undergoing a U turn;

FIG. 5A is an example of a tire building drum layed out circumferentially for illustration purposes illustrating a first full revolution or first winding of the strip layup forming the zigzag belt for the specific case of 1 zigzag per drum revolution;

FIG. 5B is the tire building drum of FIG. 5A illustrating the second revolution of the drum showing the first and second winding of the strip layup forming the zigzag belt for the specific case of 1 zigzag per drum revolution;

FIG. 5C is the tire building drum of FIG. 5A illustrating the third revolution of the drum showing the first, second and third winding of the strip layup forming the zigzag belt for the specific case of 1 zigzag per drum revolution;

FIG. 5D is the tire building drum of FIG. 5A illustrating the fourth revolution of the drum showing the first, second, third and fourth winding of the strip layup forming the zigzag belt for the specific case of 1 zigzag per drum revolution;

FIG. 6 illustrates the zigzag belt edge;

FIG. 7 illustrates a cross-sectional view of the zigzag belt edge at sections A-A, B-B, C-C, D-D and E-E showing the estimated overlap of layers;

FIG. 8 illustrates a cross-sectional view of the zigzag belt edge at sections A-A, B-B, C-C, D-D and E-E showing the estimated overlap of layers for the prior art zigzag belt of FIG. 1;

FIGS. 9A-9C illustrate a zigzag belt having a traverse offset of 0.1 mm, and wherein the drum offset angle is varied from 6.75 deg shown in FIG. 9A, to 13.5 deg shown in FIG. 9B, and 27 deg shown in FIG. 9c;

FIGS. 10A-10C illustrate a zigzag belt having a traverse offset of 8 mm, and wherein the drum offset angle is varied from 6.75 deg shown in FIG. 10A, to 13.5 deg shown in FIG. 10B, and 27 deg shown in FIG. 10C;

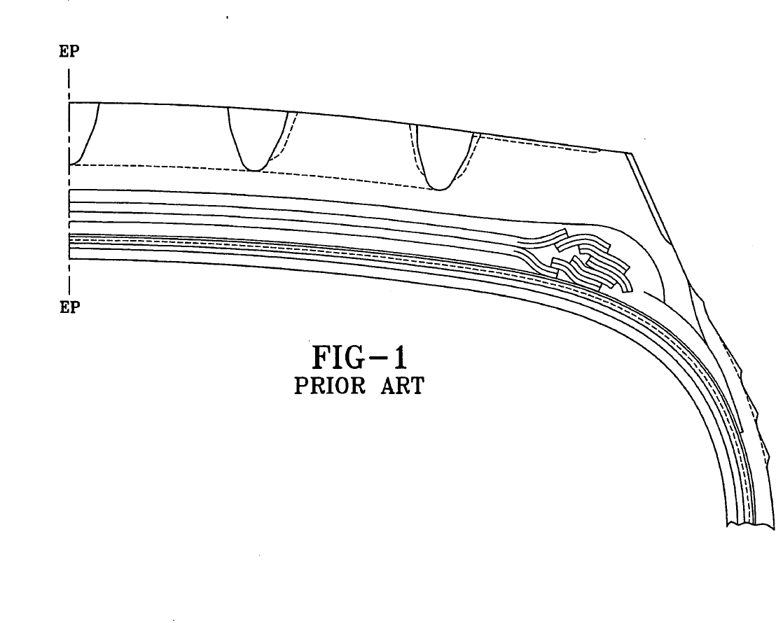

### DETAILED DESCRIPTION OF AN EXAMPLE EMBODIMENT THE INVENTION

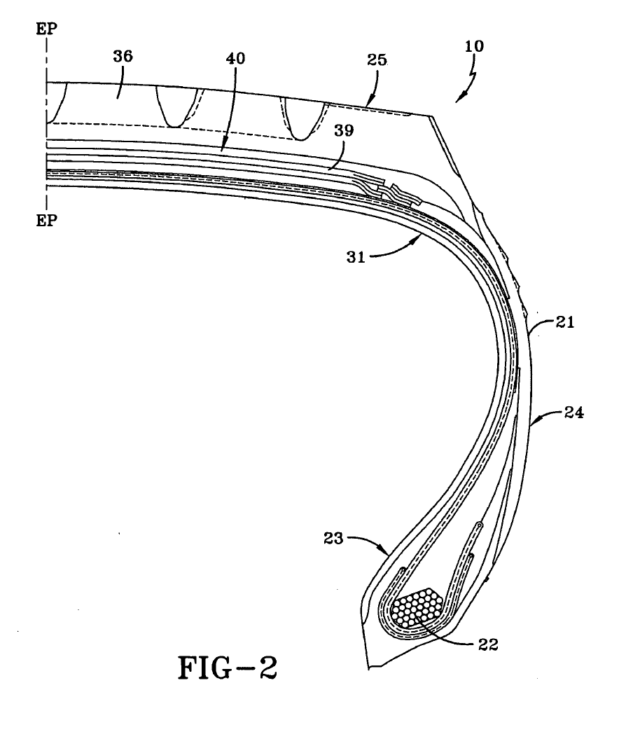

FIG. 2 illustrates a partial cross-section of an exemplary radial tire 10 which includes a bead portion 23 having a bead core 22 embedded therein, a sidewall portion 24 extending radially outward from the bead portion 23, and a cylindrical tread portion 25 extending between radially outer ends of the sidewall portions 24. The tire 10 is reinforced by a carcass 31 toroidally extending from one bead portion 23 to the other bead portion 23′ (not shown). The carcass 31 may include at least one carcass ply 32. The carcass ply 32 is anchored to the bead core and for example, may wind around each bead core 22 from inside of the tire 10 away from the equatorial plane EP to form turnup portions. A belt structure 40 is arranged between the carcass 31 and the tread portion 25.

The belt structure 40, according to an example embodiment of the present invention, comprises one or more belts, wherein at least one belt is a new and improved zigzag belt structure 39. The zigzag belt structure 39 has a modified zigzag layup pattern to reduce the number of layers at the tire shoulder. The layup of the zigzag belt structure is described as follows.

FIG. 3 illustrates a tire building drum 48 having axial circumferential edges 44, 45. In order to form the modified zigzag belt structure 39 on the tire building drum, the tire building drum is rotated as a rubberized strip 43 of cord is wound around the drum in a generally circumferential direction, extending in an alternating fashion from one drum edge 44 to the other drum edge 45.

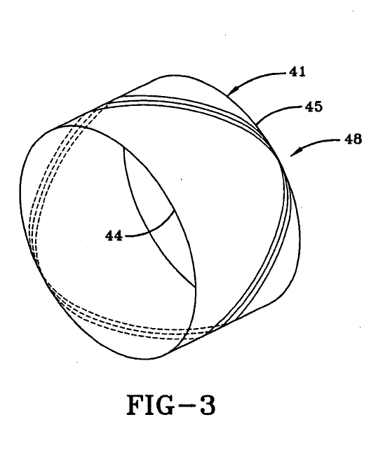

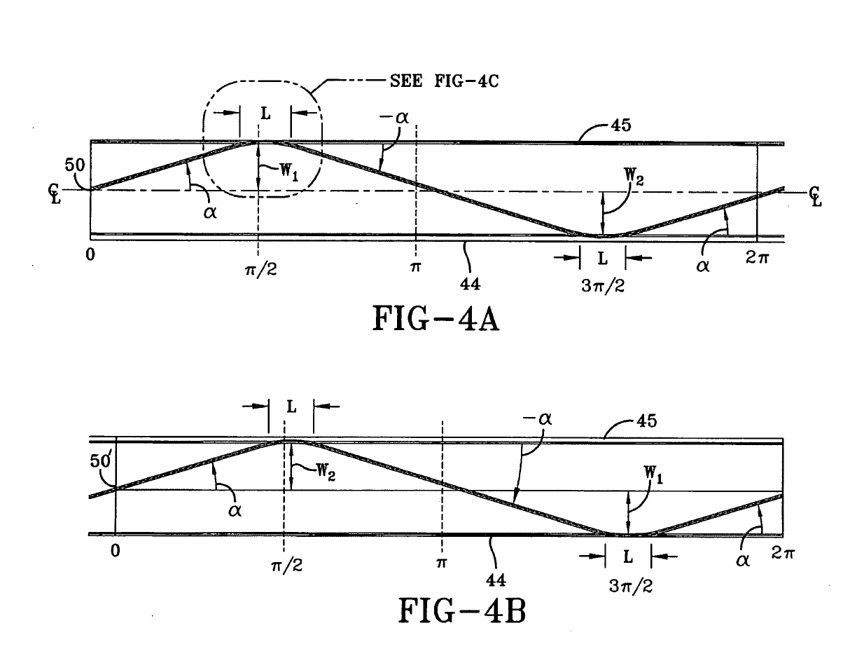

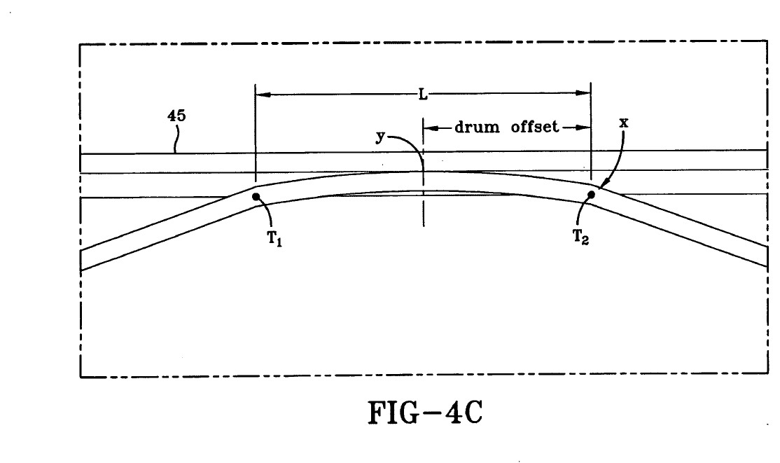

FIGS. 4a and 4b illustrate the tire building drum wherein the circumference of the drum is laid out flat, from 0 radians (degrees) to 2π radians (360 deg). FIG. 4a illustrates a first winding for a first drum revolution of the zigzag belt being formed on the drum. The invention may also be formed on a core or tire, and is not limited to being formed on a tire building drum. For illustration purposes, the initial starting point 50 will be the mid-circumferential centerplane of the drum at 0 radians, however any starting point location may be used. The strip is first angled at an angle α to the edge 45 of the tire building drum. This correlates to a location of about π/2 radians for 1 zigzag per revolution. The following description illustrates the pattern for 1 zigzag wave per revolution, and is not limited to same, as the zigzag wave per revolution. At the edge 45 of the tire building drum, the strip has a first axial width or amplitude W1, as measured from the center or mid-circumferential plane of the drum. W1 is preferably the maximum axial width located near the edge of the drum. Next, the strip may optionally continue for a distance L in a circumferential (0 degree) direction at the edge 44. As shown in FIG. 4c, the strip is preferably U turned without sharp angles, and preferably is radiused at the transition points T1 and T2. As shown in FIG. 4A, the strip is then angled at—α towards the opposite drum edge 44. At about 3/2π radians, the strip has a second axial width or amplitude W₂, which is measured from the centerplane, and is different than W1. W₁ is preferably greater than W₂. Thus the strip does not extend completely to the axial end 44 of the drum. Next, the strip may be optionally oriented in a substantially circumferential direction (0 degrees) for a circumferential distance L. Finally, the strip is angled towards the mid-circumferential centerplane at an angle α. The strip reaches the mid-circumferential centerplane at about 2π radians.

The layup of the strip for a second winding is shown in FIG. 4b. For the sake of clarity, the first winding has been removed. The starting point 50′ of the second winding has been axially indexed a desired amount, depending upon the amount of gap between successive strips desired. For illustration purposes, the second winding of the strip is indexed a strip width so it abuts with the first winding. Starting at 50′, the strip is first angled at an angle α to the edge 45 of the tire building drum. This correlates to a location of about π/2 radians for 1 zigzag per revolution. At this location, the strip has an axial width or amplitude W₂, as measured from the center or mid-circumferential plane of the drum. Next, the strip may optionally continue for a distance L in a circumferential (about 0 degree) direction at the edge 44. As shown in FIG. 4c, the strip is preferably turned at the drum edge without sharp angles, and preferably is radiused at the transition points T1, T2. As shown in FIGS. 4b and 4C, the strip is then angled from the transition point T2 at—α towards the opposite drum edge 44. At about 3/2π radians, the strip has an axial width or amplitude W₁. Next, the strip may optionally be oriented in a circumferential direction (about 0 degrees) for a circumferential distance L. As shown in FIG. 4C, the strip is preferably turned at the drum edge without sharp angles, and preferably is radiused at the transition points T1, T2. Finally, the strip is angled towards the mid-circumferential centerplane at an angle α. The strip reaches the mid-circumferential centerplane at 2π radians.

Thus in a first strip winding, the strip traversed from the starting point to a first amplitude W₁, then to a second amplitude W₂, and then back to the starting point. W1 and W1 are in opposite directions from the centerplane, and W₁≠W₂, and preferably W₁>W₂. Then in a second strip winding, the strip traversed from an indexed starting point to a first amplitude W₂, then to a second amplitude W₁, and then back to the starting point. Thus the strip windings preferably abut, but may also be overlapped or be spaced apart. The strip may also be offset circumferentially at the edges, alone, or in combination with the variable amplitude zigzag pattern.

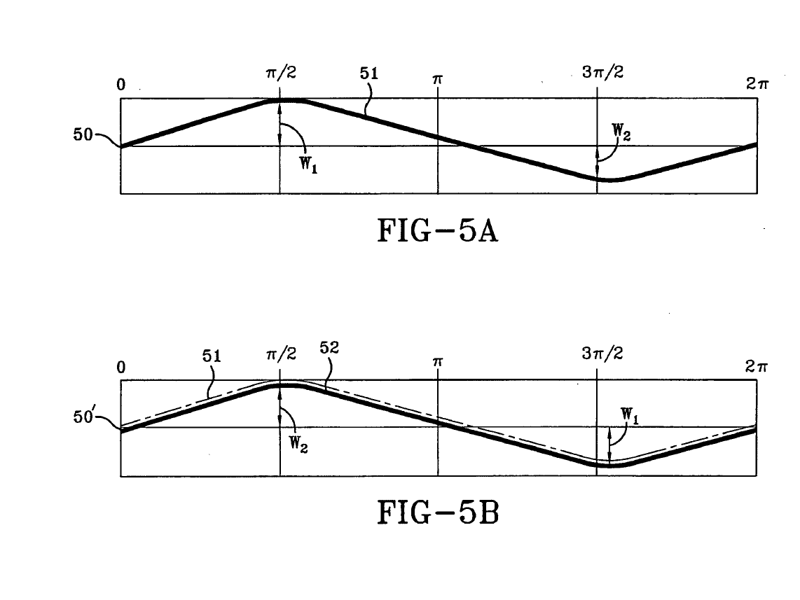

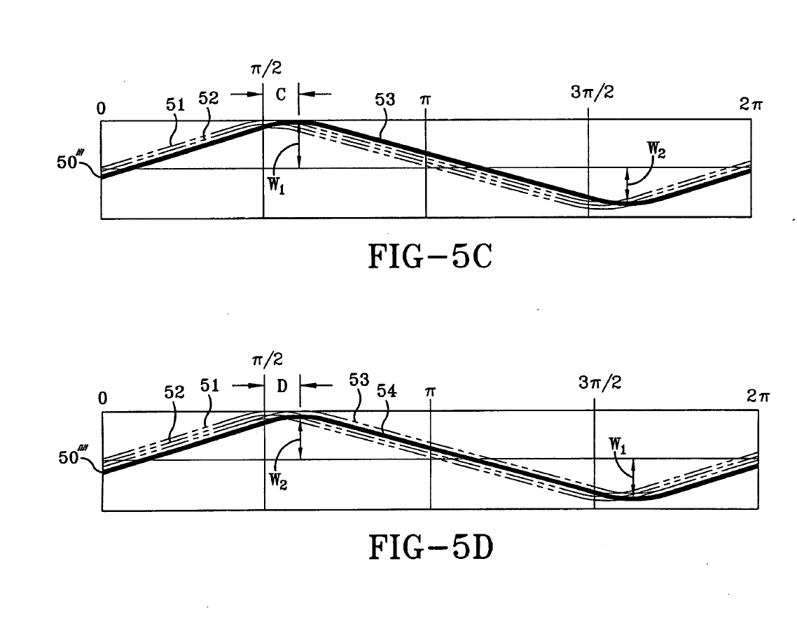

A third embodiment of the invention is now described. FIG. 5A illustrates a first winding of the strip having a first amplitude W1 followed by a second amplitude W2 in the opposite direction. FIG. 5B illustrates a second winding of the strip wherein the strip has a first amplitude W2 followed by a second amplitude W1 in the opposite direction. The second winding has been indexed a desired distance from the first winding, and thus may abut (as shown), overlap or be spaced apart.

FIG. 5C illustrates a third winding of the strip, wherein the strip winding has been circumferentially shifted or offset from the previous two windings of strip, so that the turn at the edge is offset from the edges of the previous windings. Just past the π/2 location an offset distance C, the strip has a W1 amplitude and a W2 amplitude just past the 3 π/2 location. FIG. 5D illustrates a fourth strip winding, wherein the strip is also circumferentially offset from the first, second windings, in order to reduce the belt strip gauge at the outer belt edge. As shown, just past the π/2 location at an offset distance D, the strip has a first amplitude W2 and a second amplitude W1 at an offset distance D. The offset distance D is different than the offset distance C. Preferably, the offset distance D is less than the offset distance C. In order to form the complete belt layer, the sequence as described is repeated until the belt layer is formed.

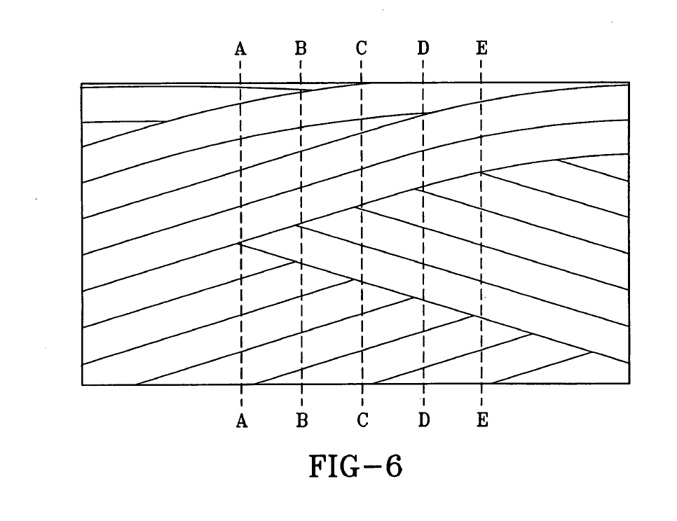

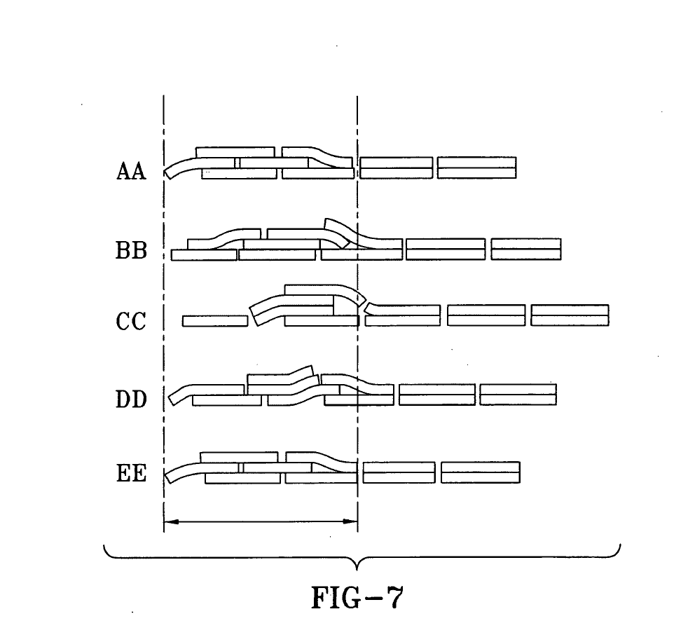

FIG. 6 illustrates a 1 zigzag wave per revolution belt in the area near the belt edge having multiple layers of strips. FIG. 7 illustrates the cross-sectional views of the belt edge taken at various locations A-A through E-E. As shown, the amount of strip overlap varies from about one layer to a maximum of 4 layers in section C-C. FIG. 8 illustrates the prior art zigzag belt layup where there are up to 6 layers overlapping each other. Thus the belt configuration of the present invention has reduced the number of overlapping layers which are believed to reduce tire durability.

The strip is formed of a rubberized ribbon of one or more cords. The width of the strip may vary, and may be for example, about 5-14 mm wide, and more preferably about 10-13 mm wide. The cord reinforcements may be formed of nylon, polyester, aramid or steel. All of the above exemplary embodiments were illustrated with 1 zigzag wave per 1 drum revolution. The invention may also include N zigzag waves per 1 drum revolution, wherein N is 0.25 or greater. N may also be an integer ≧1. For example, the strip may be layed up so that one full zigzag wave occurs in 2 full drum revolutions, or ½ zigzag per revolution. The invention as described above may also abut the strips, thus having no gap in spacing of consecutive windings. Alternatively, the successive winding of strips may be overlapped from about 1% to about 100% of the strip width. Alternatively, the successive winding of strips may have a gap distance G formed therebetween. G may vary from about 1% to about 100% of the strip width.

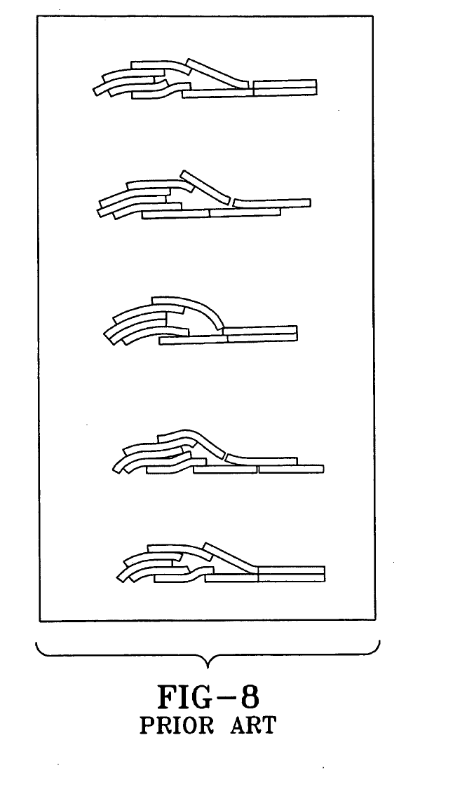

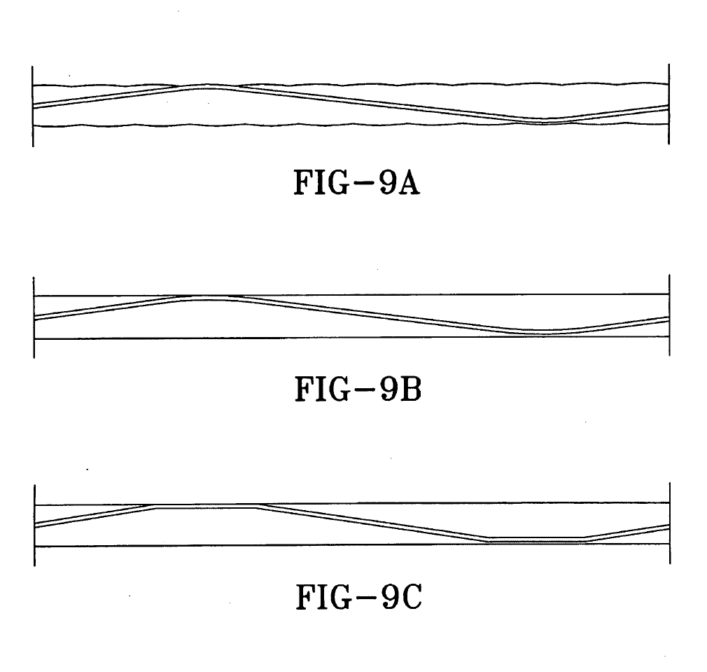

Another variable which may be utilized is the drum offset, which is best shown in FIG. 4c. The drum offset is the circumferential distance of the drum (measured in degrees or radians) from the strip edge at point Y to point X. In other words, the drum offset is half the circumferential distance over which the strip does a U-turn, as measured from the point Y closest to the edge, to the point X where the turn is completed. The drum offset or turning distance can be varied, effectively elongating the edge in the circumferential direction if increased, or resulting in a sharper turning angle if decreased. For example, the drum offset may range from about 5 degrees to about 30 degrees, and more preferably from about 10 to about 16 degrees. As the drum offset increases, the angle of the strip a also increases. FIGS. 9A-9C illustrates a strip layed upon the drum in a 1 zigzag per drum revolution. FIG. 9A illustrates a drum offset of 6.75 degrees, resulting in an α of 6.65 degrees. FIG. 9B illustrates a drum offset of 13.5 degrees, resulting in an α of 7.22 degrees. FIG. 9C illustrates a drum offset of 27 degrees, resulting in an α of 8.76 degrees. As can be seen from a review of all of the figures, as the drum offset distance is increased, the angle at the turnaround elongates along the edge and results in a smoother pass. The increase in drum offset also results in a slighter higher α. As the drum offset is increased, the amount of overlap of layers of the strip increases from 2.83 in FIG. 9A, to 3.87 in FIG. 9B, and over 6 in FIG. 9C.

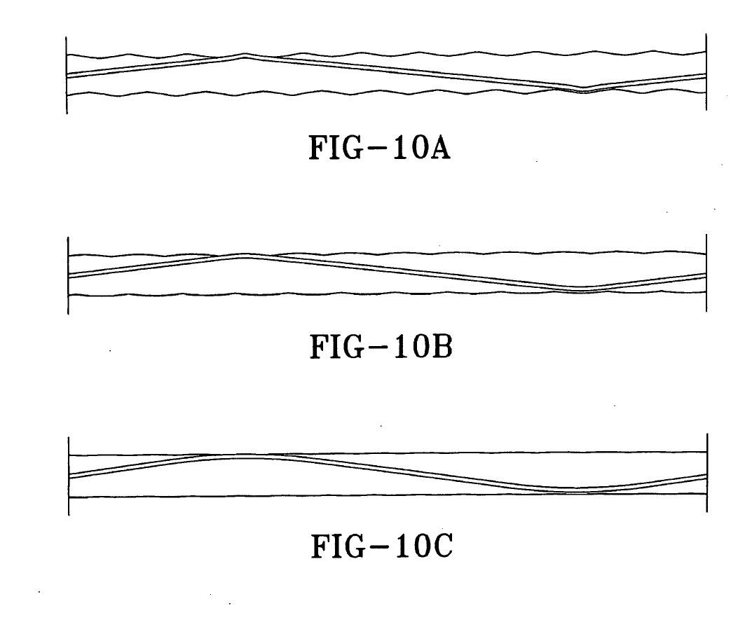

Another variable which may be utilized is the traverse offset. The traverse offset is the axial distance of the belt edge from the edge of the drum edge, in mm. By increasing the traverse offset, the strip starts to turn earlier, and can result in uneven belt edges as shown in FIGS. 10a and 10b, as compared to FIGS. 9a and 9b. FIGS. 10A-10C illustrate an 8 mm traverse offset. FIG. 10A illustrates a drum offset of 6.75 degrees, resulting in an α of 5.96 degrees. FIG. 10B illustrates a drum offset of 13.5 degrees, resulting in an α of 6.48 degrees. FIG. 10C illustrates a drum offset of 27 degrees, resulting in an α of 7.18 degrees. The effect of decreasing the traverse offset results in a belt with more even or smoother edges and a slight reduction in the circumferential angle α in the strip.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method of making a pneumatic tire comprising the steps of providing a tread, a carcass and a zigzag belt structure interposed between the carcass and the tread, and forming the zigzag belt structure of at least two layers of cords interwoven together from a strip of rubber reinforced with one or more cords,
a. forming the strip in a first zigzag winding having a first amplitude W1 followed by a second amplitude W2 extending in a direction opposite said first amplitude, wherein said amplitudes are measured from the axial centerplane, wherein W1 is different than W2,
b. indexing the strip a desired axial distance, then
c. forming the strip in a second zigzag winding having a first amplitude W2 followed by a second amplitude W1 extending in a direction opposite said first amplitude,
d. and repeating each of said windings in no particular order until the zigzag belt structure is formed.

2. The method of claim 1 wherein the strip at each lateral edge is radiused.

3. The method of claim 1 wherein strip at each lateral edge extends in a substantially circumferential direction for a specified distance L.

4. The method of claim 1 wherein the zigzag belt structure has a first belt edge in a first winding, and a second belt edge in a second winding, wherein the midpoint of the first belt edge is circumferentially offset from the midpoint of the second belt edge.

5. The method of claim 1 wherein the zigzag winding has N zigzag waves per drum revolution wherein N is ≦1.

6. The method of claim 1 wherein the zigzag winding on odd drum revolutions has belt edges which extend in the circumferential direction a distance L, and on even drum revolutions has belt edges which extend in the circumferential direction a distance L2, wherein L1≠L2.

7. A method of making a pneumatic tire comprising the following steps: providing a tread, a carcass and forming a zigzag belt structure over the carcass, wherein the zigzag belt structure is formed from the following steps: providing a strip of rubber reinforced with one or more cords,
a. Laying up the strip in a first zigzag winding, wherein the wavelength has a first amplitude: W1 and a second amplitude W2, wherein the second amplitude extends in an opposite direction of said first amplitude relative to the center plane;
b. Axially indexing the strip,
c. laying up the strip in a second zigzag winding adjacent to said first zigzag winding, wherein said second zigzag winding having a first amplitude W2 and a second amplitude W1; wherein the second amplitude extends in an opposite direction of said first amplitude relative to the center plane;
d. axially indexing the strip, and then
e. laying up the strip in a third zigzag winding adjacent to said second zigzag winding, wherein the wavelength has a first amplitude: W1 and a second amplitude W2, and wherein each edge of the third zigzag winding is circumferentially offset from the edges of the first and second zigzag winding;
f. laying up the strip in a fourth zigzag winding adjacent to said third zigzag winding wherein said fourth zigzag winding having a first amplitude W2 and a second amplitude W1; wherein each of the edges of the fourth zigzag winding are circumferentially offset from the edges of the previous windings.

8. The method of the previous claims wherein the strip is a continuous strip.

9. The method of at least one of the previous claims wherein the tire is a truck tire or a radial medium truck tire.

10. The method of at least one of the previous claims wherein the tire further comprises a helically wound circumferential belt.

11. The method of at least one of the previous claims wherein the strip has a lateral width in a range of about 5 to about 40 mm.

12. The method of at least one of the previous claims wherein the strip has a lateral width in a range of about 9 mm to about 20 mm.

13. The method of at least one of the previous claims wherein the strip has a lateral width in a range of about 12 mm to about 16 mm.

14. The method of at least one of the previous claims wherein the strip is reinforced with steel cord.

15. The method of at least one of the previous claims wherein the strip is reinforced with aramid cord.
